(19) United States
(12) Patent Application Publication
(10) Pub. No.: US 2002/0167237 A1
(43) Pub. Date: Nov. 14, 2002

(54) Fixing structure of a miniature vibration motor

(75) Inventors: Alex Horng, Kaohsiung (TW); Ching-Shen Hong, Kaohsiung (TW); Tso-Kuo Yin, Kaohsiung Hsien (TW)

Correspondence Address: Bacon & Thomas, 4th Floor, 625 Slaters Lane, Alexandria, VA, 22314, US

(73) Assignee: Sunonwealth Electric Machine Industry Co., Ltd, Kaohsiung (TW)

(21) Appl. No.: 09/852,082

(22) Filed: May 10, 2001

(51) Int. Cl. H02K 7/06; H02K 5/00; H02K 11/00

(52) U.S. Cl. 310/81; 310/89; 310/68 R

(57) ABSTRACT

A fixing stricture of a miniature vibration motor includes a circuit board having a sensor, a conducting line, conducting connecting points, and a shaft hole. The conducting connecting point on the circuit board is soldered to the line connecting point of the seat plate, so that the circuit board is fixed and combined on the seat plate. A pivot shaft in turn passes through the shaft hole of the housing, the shaft hole of the rotor, and is positioned in the shaft hole of the circuit board. The rotor has a permanent magnet induced with the poles of the stator seat. The stator seat is wound with a coil, and is connected to the conducting line of the circuit board by a drawing wire. The housing receives the stator seat and the rotor therein.

### BACKGROUND OF THE INVENTION

1. Field of the Invention

The present invention relates to a fixing structure of a miniature vibration motor, and more particularly to a fixing structure of a miniature vibration motor required with a smaller volume.

2. Description of the Related Art

A conventional miniature vibration motor in accordance with the prior art shown in FIG. 1 comprises a motor 90 fixed on the seat 92 of a circuit board 91, and then connected externally by a conducting wire 94 to a control member 95 having a drive circuit.

The conventional miniature vibration motor is usually available in the communication equipment, such as a calling machine, a mobile telephone (or cellular phone) or the like. The communication equipment is required strictly to have a light and thin design. However, the volume of such a kind of conventional miniature vibration motor is increased due to arrangement of the seat 92. In addition, the motor 90 needs to be connected externally to the drive circuit through the conducting wire 94, thereby complicating the structure, and thereby causing inconvenience.

### SUMMARY OF THE INVENTION

The primary objective of the present invention is to provide a fixing structure of a miniature vibration motor, wherein the miniature vibration motor has a simpler structure with a smaller volume, and is easily assembled and fixed.

In accordance with the present invention, there is provided a fixing structure of a miniature vibration motor including a circuit board fixed on a seat plate and having a sensor, a conducting line, conducting connecting points, and a shaft hole. The conducting connecting point on the circuit board is soldered to the line connecting point of the seat plate, so that the circuit board is fixed and combined on the seat plate. A pivot shaft in turn passes through the shaft hole of the housing, the shaft hole of the rotor, and is positioned in the shaft hole of the circuit board. The rotor has a permanent magnet induced with the poles of the stator seat. The stator seat is wound with a coil, and is connected to the conducting line of the circuit board by a drawing wire. The housing receives the stator seat and the rotor therein.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a conventional miniature vibration motor in accordance with the prior art;

FIG. 2 is an exploded perspective view of a fixing structure of a miniature vibration motor in accordance with the present invention;

FIG. 3 is a cross-sectional assembly view of the fixing structure of a miniature vibration motor as shown in FIG. 2; and

FIG. 4 is a cross-sectional view of the fixing structure of a miniature vibration motor along line 4-4 as shown in FIG. 3.

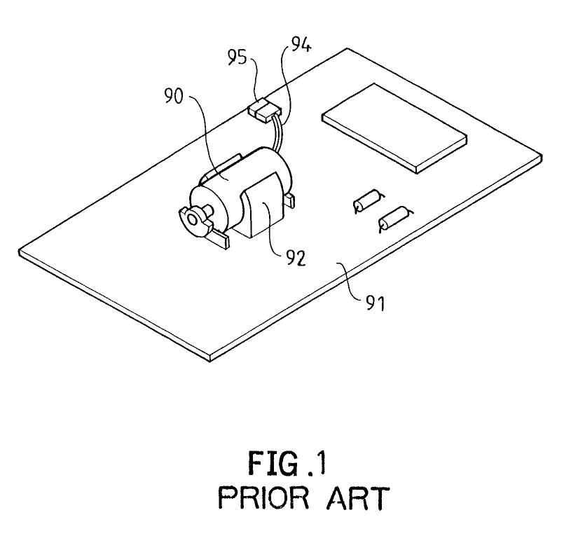

### DETAILED DESCRIPTION OF THE PREFERRED EMBODIMENTS

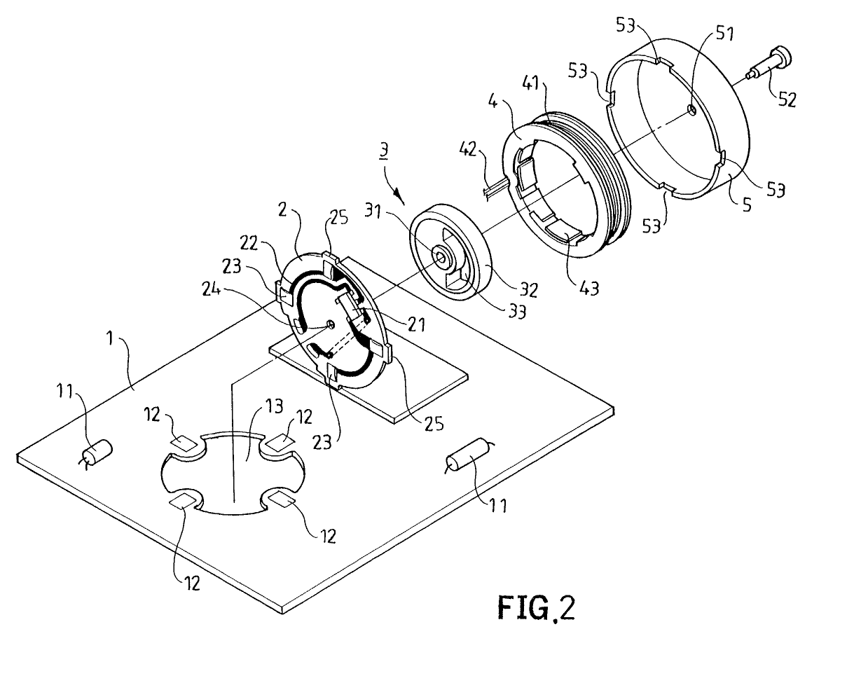

Referring to FIG. 2, in accordance with a preferred embodiment of the present invention, the miniature vibration motor is fixedly mounted on a seat plate 1, wherein the miniature vibration motor comprises a circuit board 2, a rotor 3, a stator seat 4, and a housing 5.

The seat plate 1 may be a base plate of a traditional communication equipment. The seat plate 1 includes necessary electronic elements 11, and at least one line connecting point 12 for connection and conduction of the circuit board of the miniature vibration motor, thereby forming a fixing combination. The seat plate 1 may also be provided with a seat hole 13, for positioning of the circuit board of the miniature vibration motor.

The circuit board 2 includes a Hall sensor 21, a conducting line 22, conducting connecting points 23, a shaft hole 24, and lugs 25. The conducting line 22 may be formed by printing, and connected with the coil of the stator seat 4. The circuit board 2 is provided with conducting connecting points 23 at proper positions of the conducting line 22 which are connected by soldering to the line connecting points 12 of the seat plate 1, so that the circuit board 2 and the seat plate 1 are fixed and combined with each other, and are connected in a conducting manner. The circuit board 2 has a shaft hole 24 for positioning assembly of a pivot shaft 52 which is pivoted with the rotor 3. The periphery of the circuit board 2 is protruded with lugs 25 which are locked in the cutouts 53 of the housing 53.

The rotor 3 is formed with a shaft hole 31 for pivotal passage of the pivot shaft 52 of the housing 5, and the pivot shaft 52 is positioned in the shaft hole 24 of the circuit board 2 to rotate therein. The rotor 3 has a permanent magnet 32 induced with the poles 43 of the stator seat 4, so that the rotor 3 can be driven to rotate. The center of gravity and the center of rotation of the rotor 3 are not located at the same central line. Thus, the rotor 3 forms an unbalanced vibration state during rotation. In the preferred embodiment, the rotor 3 may be formed with a slot 33, so that the rotor 3 may form an unbalanced vibration state during rotation.

The stator seat 4 is wound with a coil 41, and the drawing wire 42 is used for connection to the power supply. The stator seat 4 has poles 43. The pole 43 may change its polarity by the signal emitted from the Hall sensor 21 of the circuit board 2, and is induced with the permanent magnet 32 of the rotor 3, so that the rotor 3 is driven to rotate.

The housing 5 is formed with a shaft hole 51 for passage of the pivot shaft 52 which then passes through the shaft hole 31 of the rotor 3, and is positioned in the shaft hole 24 of the circuit board 2. The housing 5 receives the stator seat 4 therein, such that the stator seat 4 is covered and protected. The housing 5 is formed with cutouts 53 for securing the lugs 25, such that the housing 5 is fixed with a positioned effect.

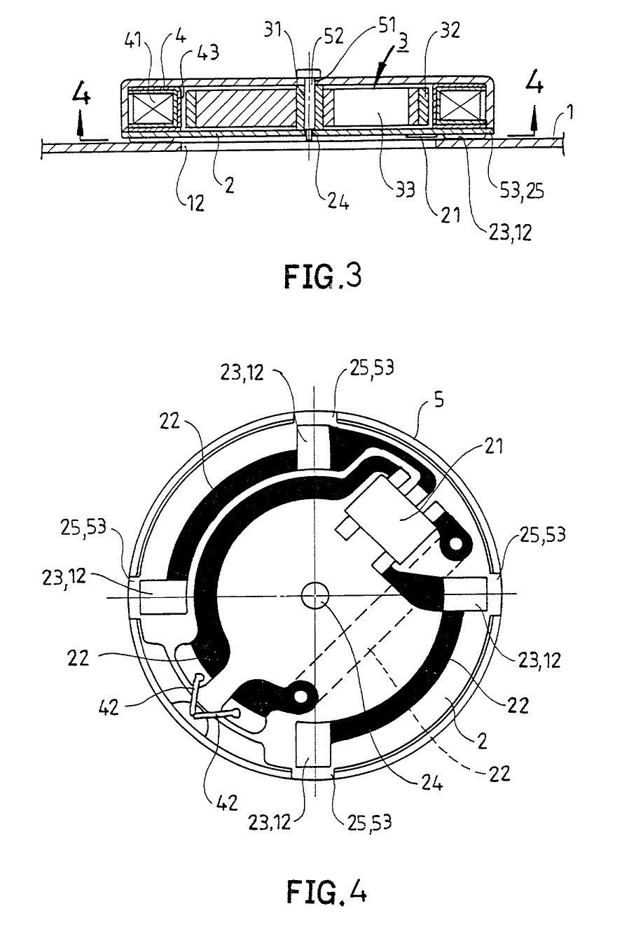

Referring to FIGS. 3 and 4, the present invention is assembled. The circuit board 1 is fixed in the seat hole 13 of the seat plate 1. The conducting 11 connecting points 23 of the circuit board 2 are respectively connected with the line connecting points 12 of the seat plate 1. The pivot shaft 51 in turn passes through the shaft hole 51 of the housing 5, the shaft hole 31 of the rotor 3, and is positioned and assembled in the shaft hole 24 of the circuit board 2. The rotor 3 is mounted in the stator seat 4, and the permanent magnet 32 of the rotor 3 is induced with the poles 43 of the stator seat 4. The drawing wire 42 of the stator seat 4 may be directly drawn to the conducting line 22 of the circuit board 2.

Accordingly, in the fixing structure of a miniature vibration motor of the present invention, the line connecting points of the seat plate are soldered on the conducting connecting points of the circuit board, such that the circuit board is fixedly combined with the seat plate. At the same time, the line on the circuit board is connected and conducted with the control line on the seat plate. In addition, the drawing wire of the stator seat is directly connected to the conducting line of the circuit board. Therefore, the entire motor is easily fixed in a simple manner, and can prevent inconvenience of drawing the line and prevent wearing of the line due to pulling. In addition, the volume of the entire motor may be decreased, and the weight of the motor may be greatly reduced. Therefore, the vibration motor of the present invention may satisfy the light, thin and small requirements of the communication equipment, and may be easily assembled and fixed.

Although the invention has been explained in relation to its preferred embodiment as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A fixing structure of a miniature vibration motor, comprising:
a seat plate, having electronic elements and at least one line connecting point;
a circuit board, having a sensor, a conducting line, and at least one conducting connecting point, the conducting connecting point soldered to the line connecting point of the seat plate, so that the circuit board is fixed on the seat plate, and so that lines between the circuit board and the seat plate are conducted;
a rotor, having a permanent magnet;
a stator seat, wound with a coil, and connected to the conducting line of the circuit board by a drawing wire, the stator seat having poles induced with the permanent magnet of the rotor; and
a housing, receiving the stator seat and the rotor therein.

2. The fixing structure of a miniature vibration motor as claimed in claim 1, wherein the seat plate is formed with a seat hole for securing the circuit board therein.

3. The fixing structure of a miniature vibration motor as claimed in claim 1, wherein the rotor is formed with a slot, such that the center of gravity and the center of rotation of the rotor are not in concert with each other.

4. The fixing structure of a miniature vibration motor as claimed in claim 1, wherein the housing is formed with cutouts, the circuit board has lugs locked in the cutouts of the housing.
